(19) United States
(12) Patent Application Publication
(10) Pub. No.: US 2025/0127096 A1
(43) Pub. Date: Apr. 24, 2025

(54) Additive Applicator System

(71) Applicant: AGCO Corporation, Duluth, GA (US)

(72) Inventor: Todd Brandon Snyder, Jackson, MN (US)

(21) Appl. No.: 18/905,454

(22) Filed: Oct. 3, 2024

Related U.S. Application Data
(60) Provisional application No. 63/592,294, filed on Oct. 23, 2023.

(51) Int. Cl. A01F 15/08; A01D 43/14

(52) U.S. Cl. CPC A01F 15/0816; A01D 43/14

(57) ABSTRACT

An additive applicator system for an agricultural cut crop is disclosed comprising a storage tank containing a quantity of liquid additive, an applicator operable to dispense the liquid additive into the cut crop, a pump between the storage tank and the applicator to drive the liquid additive from the storage tank to the applicator, a control valve between the applicator and the storage tank to control the flow of liquid additive back to the storage tank. The additive applicator system further comprises an accumulator between the pump and the applicator.

### CROSS-REFERENCE TO RELATED APPLICATIONS

This application claims the benefit of the filing date of U.S. Provisional Patent Application 63/592,294, “Additive Applicator System,” filed Oct. 23, 2023, the entire disclosure of which is incorporated herein by reference.

### FIELD

The present invention relates to a system for applying additives to agricultural crop during a harvesting process.

### BACKGROUND

Harvested crop material has a moisture content. Use of hay, straw or other cut crop material is moisture dependent. Below a moisture level of approximately 15% cut crop material is considered to be “dry”. Generally, such cut crop material may be baled and stored without a preservative. “Semi-wet” crop material, with a moisture content between approximately 15% and 30%, typically requires the addition of a preservative during a baling process or should be wrapped in an air-tight fashion shortly after the bale is formed. The addition of the preservative and/or wrapping of the bale reduces and/or eliminates spoilage of the crop material caused by mold and/or fungi. “Wet” cut crop material with a moisture content of greater than 30% is generally chopped and processed into silage and is not generally formed into a bale for storage.

It will be understood that controlling the moisture level of cut crop, both within the baling process and the cutting process (for example by a swather or windrower), has a direct effect on the suitability of the cut crop material for an intended purpose.

Known agricultural harvesting machinery include moisture sensors to enable controllers to determine the crop moisture level and communicate this to an operator. For example, large square balers may be provided with star wheels in the bale chamber to provide moisture readings, round balers may be provided with moisture sensing discs to either side of the baling chamber.

Additives may include a liquid that is stored on the agricultural harvesting machinery in a tank and applied or sprayed onto the cut crop material as the cut crop material is processed by the agricultural harvesting machinery. It is beneficial when seeking to apply a liquid additive by spraying that a spray pressure at a nozzle is at the desired pressure level as soon as possible in order that the actual amount of additive added to the cut crop material reflects as closely as possible the amount of additive intended to be added. It will be understood that the desired amount of additive will change with the moisture level of cut crop material (which is not uniform across a harvested field) during a harvesting operation.

### BRIEF SUMMARY

According to a first aspect of the present invention, an additive applicator system for an agricultural cut crop comprises a storage tank containing a quantity of liquid additive, an applicator operable to dispense the liquid additive into the cut crop, a pump between the storage tank and the applicator to drive the liquid additive from the storage tank to the applicator, a control valve between the applicator and the storage tank to control the flow of liquid additive back to the storage tank wherein the additive applicator system further comprises an accumulator between the pump and the applicator.

The accumulator provides as an advantage that fluid pressure in the line to the applicator can be maintained.

Preferably, the additive applicator system further comprises one or more moisture sensors to monitor harvested material processed by the agricultural harvesting machine

More preferably, the one or more moisture sensors comprises one or more of: an infrared sensor, a resistive sensor, an optical sensor; and a capacitive sensor.

Preferably, each of the one or more moisture sensors is mounted or otherwise coupled to the agricultural harvesting machine.

According to a second aspect of the present invention, an agricultural harvesting machine comprises an additive applicator system according to the first aspect of the invention.

According to a third aspect of the present invention, a method of operation of an agricultural harvesting machine according to the second aspect of the invention comprises the steps of setting a desired rate of spray and a desired crop moisture level using a user input apparatus to generate user input signals to be received by an electronic control unit;
detecting existing moisture levels of a harvested material being processed by the agricultural harvesting machine;
comparing the detected moisture levels with the desired moisture levels; actuating the applicator system as required;
detecting the actual flow rate of the liquid additive and comparing the actual flow rate to the input desired rate of spray to determine if the desired flow rates are being achieved and adjusting the operation of the pump as required.

According to a fourth aspect of the present invention, a control system for controlling operation of one or more controllable components of an additive applicator system, the control system comprising one or more controllers, and being configured to:
receive data indicative of a moisture level of material collected by the agricultural harvesting machine;
determine, in dependence on the moisture level, a spraying strategy for treating harvested material processed by an agricultural harvesting machine; and
generate and output one or more control signals for controlling one or more operational components associated with the agricultural harvesting machine in dependence on the determined spraying strategy.

Preferably, the one or more operational components comprises a user interface operable to provide information indicative of the determined spraying strategy to an operator of the baler.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

The invention will now be described, by way of example only, with reference to the accompanying drawings, in which:

FIG. 1 shows in schematic form elements of an additive applicator system in accordance with the present invention;

FIG. 2 shows in schematic form an embodiment of a control system for operation of the additive applicator system;

FIG. 3 shows in schematic form a first agricultural harvesting machine incorporating an additive applicator system in accordance with the present invention;

FIG. 4 shows in schematic form a second agricultural harvesting machine incorporating an additive applicator system in accordance with the present invention; and

FIG. 5 shows a flow diagram illustrating a method of operation of the additive applicator system.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

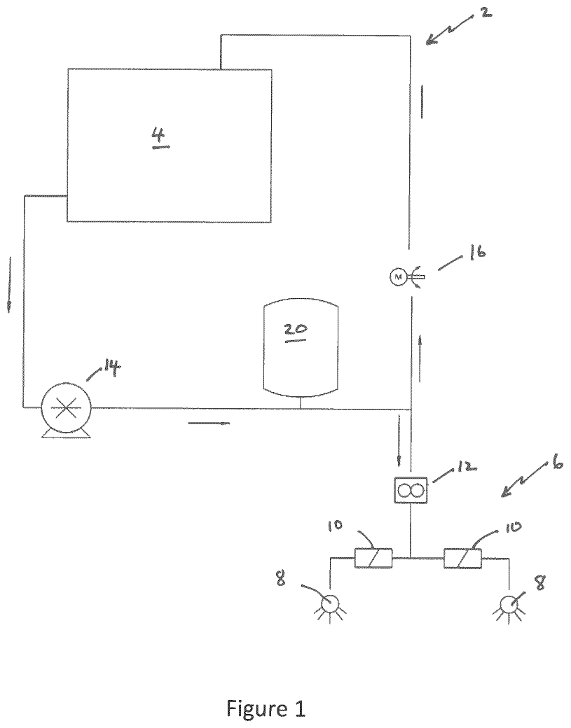

With reference to FIG. 1, an additive applicator system 2 is shown schematically.

A storage tank 4 may be used to store a quantity of liquid additive. The storage tank 4 may be refilled by an operative with desired liquid additive, for example a desired mixture of liquid preservative. The storage tank 4 is in liquid communication with a number of other elements.

An applicator 6 operable to dispense the liquid additive into the cut crop is provided. The applicator 6 conveniently compromises a plurality of spray nozzles 8, each provided with an on/off valve 10.

In an alternative embodiment the on/off valves 10 may be omitted.

The applicator 6 further conveniently comprises a flow meter 12 upstream of the on/off valves 10 to monitor the fluid pressure in the applicator 6.

A pump 14 is located in line between the storage tank 4 and the applicator 6. The pump is operable to drive the liquid additive from the storage tank 4 to the applicator 6.

A control valve 16 is located in line between the applicator 6 and the storage tank 4 to control the flow of unused liquid additive back to the storage tank 4.

The additive applicator system 2 further comprises an accumulator 20 between the pump 14 and the applicator 6.

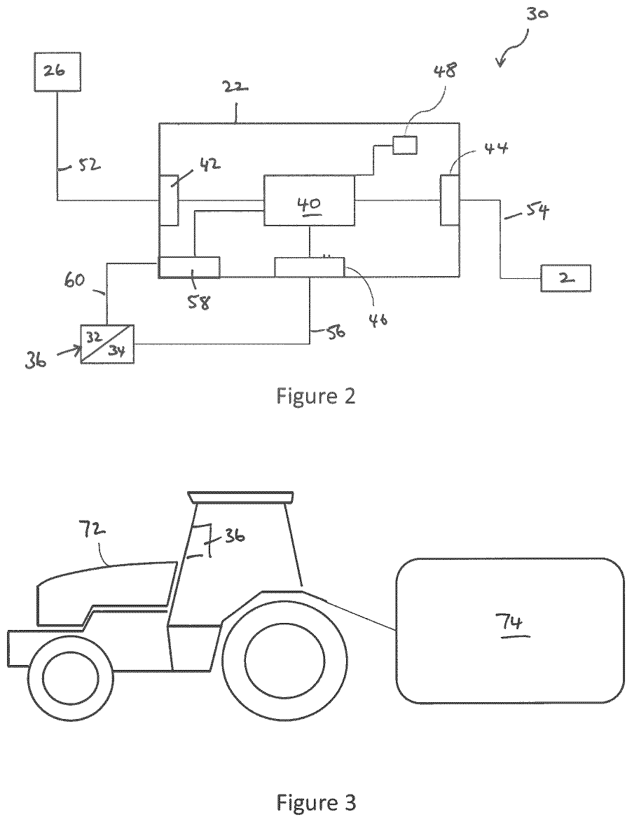

An electronic control unit 22 (FIG. 2) is in electronic communication with the pump 14, the control valve 16 and the on/off valves of the additive applicator system 2.

The electronic control unit 22 may comprise a single processor located on an agricultural harvesting machine, or multiple processors in electronic communication with one another. For example, where the agricultural harvesting machine is a towed apparatus, the electronic control unit may comprise a first processor located on the towed apparatus and a second processor located on the towing vehicle, for example located on a tractor.

Conveniently the electronic control unit is also in electronic communication with moisture sensors of the agricultural harvesting machine. The electronic control unit 22 may also be in contact with one or both of a user input apparatus 32 and user output apparatus 34. While a separate user input apparatus 32 and user output apparatus 34 may be provided, these may usefully be combined into a single user interface 36, for example a touch sensitive display screen.

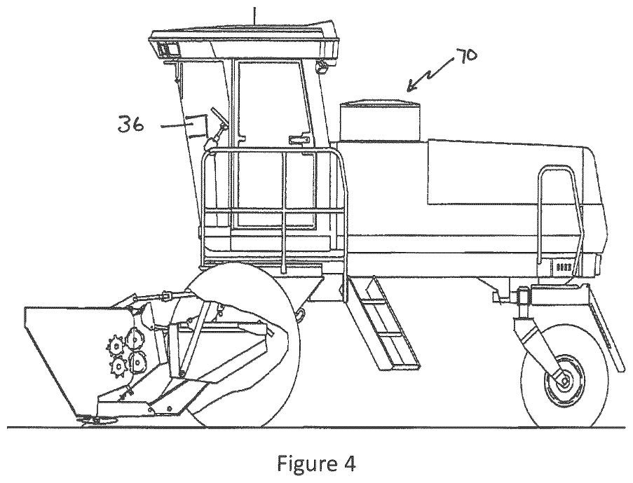

The user terminal 36 may be located in an agricultural harvesting machine, in the case of a self-propelled windrower 70, or on board a towing vehicle 70, in the case of a towed agricultural harvesting machine 74 such as baler or mower (FIGS. 3 and 4).

Alternatively, the user terminal 36 may take the form of a separate electronic apparatus, such as a mobile communication device operating appropriate application software. In this example it will be understood that the electronic control unit additionally includes the processor of the electronic apparatus.

An example embodiment of a control system 30 is shown in FIG. 2. The control system 30 comprises a electronic control unit 22 having an electronic processor 40, electronic inputs 42,58 and electronic outputs 44,46. The processor 40 is operable to access a memory 48 of the electronic control unit 22 and execute instructions stored therein to perform the steps and functionality of the present invention discussed herein, e.g. by controlling the user interface 36, to indicate, e.g. to an operator, information indicative of the current spraying strategy, and/or controlling operation of the additive applicator system 2 through generation and output of one or more control signals thereto.

The processor 40 is operable to receive sensor data via input 42 which, in the illustrated example, takes the form of input signals 52 received from a moisture sensor 26. The moisture sensor may comprise one or more of: an infrared sensor, a resistive sensor, an optical sensor; and a capacitive sensor. The moisture sensor may be mounted or otherwise coupled to the agricultural harvesting machine.

Utilising this data, the processor 40 is configured to analyse the data and determine therefrom a measure of a moisture level associated with the material processed by the agricultural harvesting machine. As discussed herein, the determined moisture level is used to determine a strategy for operation of the applicator system 2, and in particular an indication of a required operation of the additive applicator system 2. A notification indicative thereof can be presented to an operator of the agricultural harvesting machine via the user interface 36.

The processor 40 is also operable to receive user input data via input 58 which, in the illustrated example, takes the form of user input signals 60 received from the user input apparatus 32. The user input signals 60 can be used to set a desired rate of spray and a desired crop moisture level.

As described above, the electronic control unit 22 includes an electronic output 44 configured to output control signals 54 generated by the processor 40 for controlling operation of the applicator 6. Specifically, processor 40 is operable to generate, and the electronic control unit 22 operable to then output via output 44, control signals 54 for controlling operation of the pump 14, the on/off valves 10 or the control valve 16 of the additive applicator system 2.

Output 46 is operably coupled to the user interface 54 of the agricultural harvesting machine. Here, the control system 30 is operable to control operation of the user interface 36, e.g. through output of control signals 56 in order to display data to an operator of the agricultural harvesting machine relating to the operation of the applicator system 2. Specifically, the control system 30 is operable to control the user interface 36 to display to the operator an indicator of the spraying strategy being implemented.

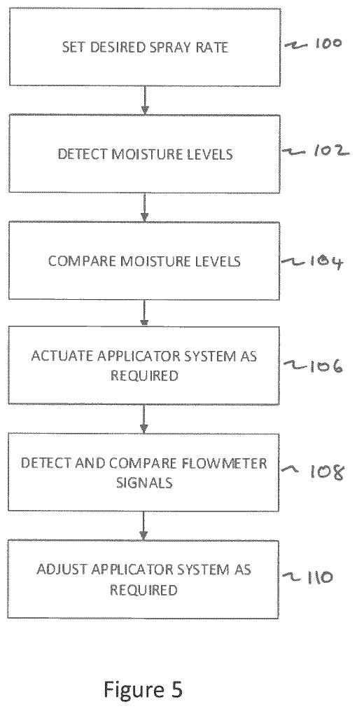

In use, an operator can set a desired rate of spray and a desired crop moisture level using the user input apparatus 32 (Step 100, FIG. 5) to generate the user input signals to be received by the electronic control unit 22. In a first example, the electronic control unit 22 then receives the control signals from the moisture sensors (step 102).

The electronic control unit 22 then compares the detected moisture levels with the desired moisture levels (step 104) and if additional moisture is required actuates the applicator system for example by operation of the pump (and where appropriate operation of the on/off valves 10 and/or control valve 16) (step 106).

The electronic control unit 22 then compares the signals from the flow meter to the input desired rate of spray to determine if the desired flow rates are being achieved (step 108) and adjust the operation of the pump 14 as required (step 110).

In a further example, the electronic control unit also causes a visual representation of the operation of the applicator control system to be displayed on the user output apparatus, for example by way of a series of images displayed on the user output apparatus illustrating one or both of the moisture level being detected and the flow rate of the applicator system (whether as an absolute value or in comparison to the user input values).

All references cited herein are incorporated herein in their entireties. If there is a conflict between definitions herein and in an incorporated reference, the definition herein shall control.

From reading the present disclosure, other modifications will be apparent to persons skilled in the art. Such modifications may involve other features which are already known in the field of forage harvesters and component parts therefore and which may be used instead of or in addition to features already described herein.

What is claimed is:

1. An additive applicator system for an agricultural cut crop comprises a storage tank containing a quantity of liquid additive, an applicator operable to dispense the liquid additive into the cut crop, a pump between the storage tank and the applicator to drive the liquid additive from the storage tank to the applicator, a control valve between the applicator and the storage tank to control the flow of liquid additive back to the storage tank wherein the additive applicator system further comprises an accumulator between the pump and the applicator.

2. An additive applicator system according to claim 1, further comprising one or more moisture sensors to monitor harvested material processed by the agricultural harvesting machine.

3. An additive applicator system according to claim 2, wherein the one or more moisture sensors comprises one or more of: an infrared sensor, a resistive sensor, an optical sensor; and a capacitive sensor.

4. An additive applicator system according to claim 2, wherein each of the one or more moisture sensors is mounted or otherwise coupled to the agricultural harvesting machine.

5. An agricultural harvesting machine comprising an additive applicator system according to claim 1.

6. A method of operation of an agricultural harvesting machine according to claim 5 comprising the steps of setting a desired rate of spray and a desired crop moisture level using a user input apparatus to generate user input signals to be received by an electronic control unit;
detecting existing moisture levels of a harvested material being processed by the agricultural harvesting machine; comparing the detected moisture levels with the desired moisture levels;
actuating the applicator system as required; detecting the actual flow rate of the liquid additive and comparing the actual flow rate to the input desired rate of spray to determine if the desired flow rates are being achieved and adjusting the operation of the pump as required.

7. A control system for controlling operation of one or more controllable components of an additive applicator system, the control system comprising one or more controllers, and being configured to: receive data indicative of a moisture level of material collected by an agricultural harvesting machine; determine, in dependence on the moisture level, a spraying strategy for treating harvested material processed by the agricultural harvesting machine; and generate and output one or more control signals for controlling one or more operational components associated with the agricultural harvesting machine in dependence on the determined spraying strategy.

8. A control systema according to claim 7, wherein the one or more operational components comprises a user interface operable to provide information indicative of the determined spraying strategy to an operator of the baler.
